(19) United States
(12) Patent Application Publication
(10) Pub. No.: US 2004/0115113 A1
(43) Pub. Date: Jun. 17, 2004

(54) Method for the continuous production of salt mixtures

(76) Inventor: Hans-Leonhard Ohrem, Seeheim-Jugenheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/474,329

(22) PCT Filed: Mar. 14, 2002
(86) PCT No.: PCT/EP02/02836

(30) Foreign Application Priority Data
Apr. 11, 2001 (DE) 101 18 234.1

(51) Int. Cl. C01F 5/38

(52) U.S. Cl. 423/395

(57) ABSTRACT

The invention relates to a method for the continuous production of salt mixtures. Apparatus, which generally is sealed, is used for this purpose. Said apparatus consists of dosage devices for the required raw materials, a solid matter feed, a reaction vessel and a filtration device, which arc controlled via online analytics. The invention also relates to a salt mixture produced according to said method and to the use thereof.

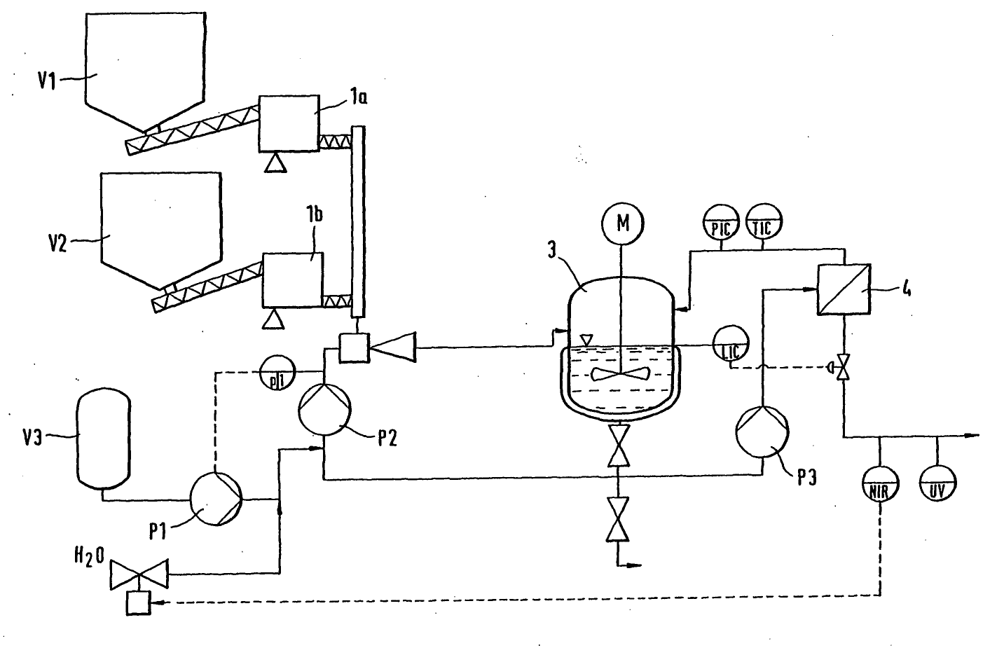

The invention relates to a process for the continuous preparation of salt mixtures. For this purpose, use is made of an apparatus, generally closed, which consists of metering devices for the requisite raw materials, a solids feed, a reactor and a filtration device, which are controlled via on-line analysis. The invention also relates to a salt mixture prepared by this process, and to the use thereof.

EP-B 0 616 630 discloses a salt mixture of the composition Mg(NO₃)₂.6H₂O/LiNO₃, which can be used as latent heat storage system, in particular for use in motor vehicles. This mixture is prepared by melting together the two starting components. However, this preparation method is inconvenient, requires a considerable amount of time and is expensive.

The object of the present invention is to avoid the disadvantages of the prior art. In order to exclude corrosion on the equipment parts on use of the salt mixture in practice, it is desirable for the pH to be as neutral as possible (pH 5-8) and for the iron content to be as low as possible.

The invention relates to a process for the continuous preparation of salt mixtures based on magnesium nitrate and lithium nitrate, characterised in that

the two solid raw materials MgO and LiOH.H₂O are fed individually or pre-mixed via a gravimetric metering device (1a and 1b) to a reactor (3) containing dilute nitric acid,

the reaction for the formation of a melt of the salt mixture is initiated by the heat of reaction formed,

when the reaction is complete, the melt is fed via a pump (P3) to a filtration device (4), and the product is discharged therefrom,

the entire course of the process being controlled by on-line analysis.

The reaction temperature maintains the internal temperature of the reactor at the desired level throughout the process and causes the formation of a melt due to dissolution of the components.

The present process is distinguished by good practicability, by the use of simple starting materials and by low costs.

The salt mixture formed is a eutectic mixture comprising 83.7 parts by weight (pbw) of Mg(NO₃)₂.6H₂O and 16.3 pbw of LiNO₃, which corresponds to a ratio of 40 mol % of LiNO₃ to 60 mol % of Mg(NO₃)₂. It has a single sharp maximum in the melting range from about 71 to 78° C. with a centre at 75.6° C. and a heat of melting or phase conversion of 171.5 J/g. This mixture is extremely stable and exhibits no change in the phase-conversion point and the heat of conversion, and thus also no phase separation, over an unlimited number of melting and solidification cycles. It is also surprising that an iron content of ≦0.75 μg/g which satisfies the demands regarding a clear melt and white crystals can be achieved in the process. It is likewise surprising that the pH of the filtered melt is in the neutral range.

The process in accordance with the present invention is described in the scheme shown. The starting materials employed are MgO and LiOH.H₂O, which are introduced continuously into a reactor (3) fitted with a stirrer, either as a stoichiometric mixture or preferably individually from the stock tanks V1 and V2 via gravimetric metering devices (1a) and (1b). Dilute HNO₃ (about 71%) from the stock vessel (V3) is metered into (3) in parallel or formed from conc. HNO₃ and water and fed into (3) via the pumps (P1) and (P2). In order to achieve good dispersal of the solid starting materials, a dispersing solids feed is preferred.

The reaction, i.e. the continuous preparation of the melt in the reactor (3), takes place autothermally. This means that the exothermicity of the process is sufficient to keep the internal temperature in the reactor at the desired level and no further heating energy is required. It is generally about 90° C., but may also adopt higher values through various measures. The temperature has a positive effect on the dissolution rate, which is in turn dependent on the size of the reactor (3). If the temperature in a closed apparatus is increased, the dissolution rate increases simultaneously. In general, temperatures of from about 80 to 150° C., preferably up to 110° C., are used. A closed apparatus is necessary in the case of the higher values since the dissolution rate and thus the requisite residence time in the dissolution process as well as the specific enthalpy of melting are affected by a change in the water content of the melt. The mean residence time in the reactor (3) is generally from 10 to 20 hours, preferably 5 hours, but can be reduced to one hour through suitable measures (for example temperature, mixing intensity, water content).

The pH likewise has a major effect on the dissolution rate and also on the filterability of Fe impurities. It has been found that the ratios for the two parameters are optimum at an indicated value of pH 0.5. Fe impurities can be successfully removed in this way, and the dissolution rate is also within the range of values. It is surprising that the pH of the melt can be measured and regulated using a commercially available electrode, although the pH of the melt cannot be measured in the actual sense since the usual probe measurement is based on dilute aqueous solutions. Commercially available instruments, for example a gel electrode (manufacturer Ingold, Germany), are therefore used here.

The melt is removed continuously from the reactor (3) and fed to filtration. To this end, it is passed via a pump (P3) to a commercially available filter system (4). Filtration via deep-bed filter layers, automated sponge filtration, deep-bed filtration in cushion modules and preferably membrane filtration with the aid of a ceramic membrane have proven successful. After the filtration, the product obtained is discharged.

The course of the process is controlled in the plant with the aid of on-line analysis. It is advisable to measure the following critical parameters:

a) water content,

b) Fe content,

c) pH,

d) Li/Mg ion ratio, and

e) mass flow rate, fill level, pressure and temperature in the reactor (3).

The measurement of the water content is necessary during metering of dilution water in the case of acid adjustment, but is also appropriate at other points at which the water content has to be monitored. The iron content of the melt is evident from a yellow-brown coloration. The iron content can be determined here in the reactor (3) but especially in the product stream after the filtration (4). The Li/Mg ion ratio can be controlled, for example, by control of the gravimetric metering devices for the components. The mass flow rate into the reactor (3) can likewise be measured and regulated via the gravimetric metering devices.

Process monitoring by means of the said parameters can be measured at various points of the process using conventional, commercially available measurement technology.

In general, the process is carried out in the melt without addition of excess water. However, it may occasionally be desirable to use an excess of water, for example in order to increase the dissolution rate and thus to reduce the mean residence time required. In this case, a continuous evaporator should be incorporated into the work flow after the dissolution process. It should then be ensured that the water content is also monitored at this point.

The salt mixture obtained by the continuous process according to the invention is distinguished by high purity, a specific composition and by inexpensive preparation.

It is therefore particularly suitable as latent heat storage system for the storage and utilisation of the waste heat from heat sources, for example internal-combustion engines of all types; preferably for use in motor vehicles. However, the waste heat from the use of stationary internal-combustion engines, for example in power generation and in ships' engines, can also be stored and utilised, for example for the production of hot service water or for heating purposes. This storage system can also be employed for other heat-generating sources if the heat of phase conversion is sufficient, for example in domestic appliances or for the storage of solar energy. It is appropriate in all cases where heat at more than 80° C. is in excess-and can be used in this temperature range.

1. Process for the continuous preparation of salt mixtures based on magnesium nitrate and lithium nitrate, characterised in that the two solid raw materials MgO and LiOH×H₂O are fed individually or pre-mixed via a gravimetric metering device (1a and 1b) to a reactor (3) containing dilute nitric acid, the reaction for the formation of a melt of the salt mixture is initiated by the heat of reaction formed, when the reaction is complete the melt is fed via a pump (P3) to a filtration device (4), and the product is discharged therefrom, the entire course of the process being controlled by on-line analysis.

2. Process according to claim 1, characterised in that the internal temperature in the reactor is kept at the desired level throughout the process by the heat of reaction.

3. Process according to claim 1 or 2, characterised in that the melt is formed by dissolution of the components.

4. Process according to one or more of claims 1 to 3, characterised in that the raw materials are employed in a ratio of 40 mol % of LiNO₃ to 60 mol % of Mg(NO₃)₂.

5. Process according to one or more of claims 1 to 4, characterised in that the feed of the solid raw materials takes place in the form of a dispersing solids feed.

6. Process according to one or more of claims 1 to 5, characterised in that the internal temperature in the reactor is from 80 to 150° C., preferably 110° C.

7. Process according to one or more of claims 1 to 6, characterised in that the residence time is from 10 to 20 hours, preferably 5 hours.

8. Salt mixture prepared by the process according to one or more of claims 1 to 7.

9. Use of the salt mixture according to claim 8 as latent heat storage system for the storage and utilisation of the waste heat from heat sources.

10. Use according to claim 9 in internal-combustion engines of all types, preferably in motor vehicles, further in stationary internal-combustion engines in power generation and in ships' engines.
